(19) United States
(12) Patent Application Publication
(10) Pub. No.: US 2003/0076794 A1
(43) Pub. Date: Apr. 24, 2003

(54) Checksum rewrite device

(76) Inventors: Takeshi Kawasaki, Kawasaki (JP); Naotoshi Watanabe, Kawasaki (JP); Hiroyasu Hirata, Osaka (JP); Junichi Morimoto, Osaka (JP)

Correspondence Address: KATTEN MUCHIN ZAVIS ROSENMAN, 575 MADISON AVENUE, NEW YORK, NY, 10022-2585, US

(21) Appl. No.: 10/116,548

(22) Filed: Apr. 4, 2002

(30) Foreign Application Priority Data
Oct. 18, 2001 (JP) 2001-320958

(51) Int. Cl. H04L 12/28; H04L 12/56

(52) U.S. Cl. 370/329; 714/807

(57) ABSTRACT

The present invention is a checksum rewriting device for rewriting a checksum value. This device includes a translating means for, in a case where a packet is inputted having at least one header consists of a plurality of fields including a checksum field is inputted, translating a value of a predetermined field other than the checksum field; a difference value storing means for storing a checksum difference value calculated using a pre-translated value and a translated value of the predetermined field which is translated by the translating means; and a rewriting means for rewriting the value of the checksum field in the header in the packet in which the predetermined field value has been translated by the translating means, to a new value, using the difference value stored in the difference value storing means.

### BACKGROUND OF THE INVENTION

1. Field of the Invention

The present invention relates to a header translation device for recalculating a checksum at a time when header information is rewritten.

2. Description of the Related Art

Conventionally, as a measure of dealing with increase of server access, load distributing is performed to a plurality of server. When the load distributing is performed to a plurality of server, consideration is also given to a shortage of IP (Internet Protocol) addresses due to increased Internet usage in recent years, and thus a technique is used for performing header translation on an IP header and TCP/UDP header, such as translating an IF address for a TCP (Transmission Control Protocol) session and translating a TCP/UDP (User Datagram Protocol) port number, a Sequence number and an Acknowledge number.

In a plurality of fields included in a packet, the checksum value of the translated packet changes, when a value of a field among these that is to become a calculation subject for calculating a checksum value (hereinafter, referred to as “the subject field”) is translated. Normally, when the translation of the IP header and TCP/UDP header is performed, the field that is translated is the subject field. Therefore, when the IP header and TCP/UDP header are translated, it is necessary to recalculate and rewrite the checksum value according to the value of the subject field to be translated.

Conventionally, the value in the subject field before the header translation is performed, and the checksum value, are first used to confirm integrity of a packet in a transmission from a sending source to a header translation device. Then, after the integrity of the sent packet is confirmed, the translation of the IP header or the TCP/UDP header is executed, and the checksum value in the IP header and the checksum value in the TCP/UDP header are recalculated based on the value in the subject field after the translation.

However, in the checksum recalculation, every value in the subject field is considered. Therefore, the amount of time required for the calculations is not ignored. Accordingly, the amount of time required for the checksum recalculations is an obstacle inhibiting acceleration of data transmission. In particular, since the integrity confirmation using the TCP/UDP checksum value and the recalculation of the value are performed on the IP address field and the entire TCP/UDP datagram, the processing requires a significant number of hardware resources and amount of time. Further, for a packet that is fragmented, data areas of all the fragmented packets are considered; therefore, even more number of hardware resources and amount of time are required.

### SUMMARY OF THE INVENTION

The present invention has as an object to provide a header translation device for reducing the amount of time required for the checksum recalculation that is performed at the time of the header translation.

In order to achieve the above-mentioned problem, the present invention adopts the following structure. That is, according to the present invention, there is provided a checksum rewriting device comprising: a translating means for, in a case where a packet having at least one header consists of a plurality of fields including a checksum field is inputted, translating a value of a predetermined field other than the checksum field; a difference value storing means for storing a checksum difference value calculated using a pre-translated value and a translated value of the predetermined field which is translated by the translating means; and a rewriting means for rewriting the value of the checksum field in the header in the packet in which the predetermined field value has been translated by the translating means, to a new value, using the difference value stored in the difference value storing means.

In accordance with the present invention, the translating means translates the value of the predetermined field other than the checksum field, the difference value storing means stores the difference value of the checksum calculated using the pre-translated value and the translated value of the predetermined field, and the rewriting means uses the difference value stored in the difference value storing means, to rewrite the value of the checksum in the packet in which the predetermined field value was translated. Accordingly, it becomes unnecessary to calculate the checksum difference value each time the rewriting means rewrites the checksum value.

### BRIEF DESCRIPTION OF THE DRAWINGS

In the accompanying drawings:

FIG. 1 is a diagram showing a basic construction of the present invention;

FIG. 2 is a functional block diagram showing an IP address translation device according to a first embodiment of the present invention;

FIG. 3 is a diagram showing in detail an address generating section according to the first embodiment of the present invention;

FIG. 4 is a diagram showing in detail an address translating section according to the first embodiment of the present invention;

FIG. 5 is a diagram showing in detail a checksum difference calculating section according to the first embodiment of the present invention;

FIG. 6 is a diagram showing in detail a checksum difference storing section according to the first embodiment of the present invention;

FIG. 7 is a diagram showing in detail a checksum translating section according to the first embodiment of the present invention;

FIG. 8 is a functional block diagram showing a URL load distributing system according to a second embodiment of the present invention;

FIG. 9 is a diagram showing data handled by the URL load distributing system at URL load distributing according to the second embodiment of the present invention;

FIG. 10 is a diagram showing in detail a replacement data generating section according to the second embodiment of the present invention;

FIG. 11 is a diagram showing in detail a field translating section according to the second embodiment of the present invention;

FIG. 12 is a diagram showing in detail a checksum difference calculating section according to the second embodiment of the present invention;

FIG. 13 is a diagram showing in detail a checksum difference storing section according to the second embodiment of the present invention;

FIG. 14 is a diagram showing in detail a checksum translating section according to the second embodiment of the present invention;

FIG. 15 is a functional block diagram showing an IP address translation device according to a third embodiment of the present invention;

FIG. 16 is a diagram showing in detail an address generating section according to the third embodiment of the present invention;

FIG. 17 is a diagram showing in detail an address translating section according to the third embodiment of the present invention; and

FIG. 18 is a diagram showing in detail a checksum translating section according to the third embodiment of the present invention.

### DETAILED DESCRIPTION OF THE PREFERRED EMBODIMENTS

<Principle of the Present Invention>

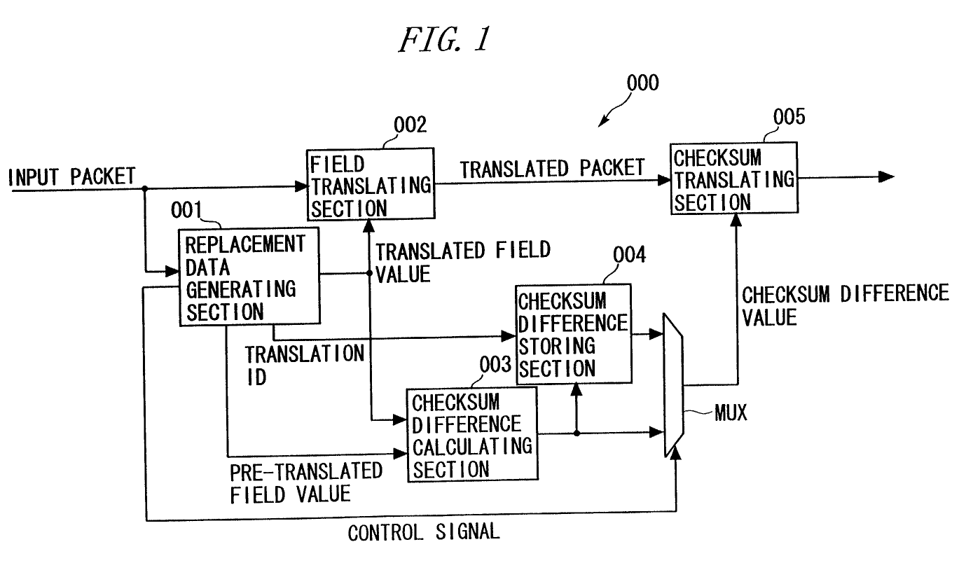

First, explanation is made of a principle of the present invention. FIG. 1 is a diagram showing the principle of the present invention. In FIG. 1, a header translation device 000 (corresponding to a “checksum rewriting device” of the present invention) is provided with a replacement data generating section 001, a field translating section 002, a checksum difference calculating section 003, a checksum difference storing section 004, a checksum translating section 005 and a multiplexer MUX.

The replacement data generating section 001 receives an inputted packet (input packet), and in response to header information therein, passes a translated value to the field translating section 002 (corresponding to “translating means” of the present invention). The packet has at least one header provided with a plurality of fields including a checksum field. Here, the field value in pre-translated header information that will be a translation subject is referred to as a pre-translated field value; and the field value in the after-translation header information that is the translation subject is referred to as an translated value.

Further, the replacement data generating section 001 generates a translation ID for solely determining a combination of the pre-translated field value and the translated value, matches the pre-translated field value, the translated value and the translation ID, and stores them in a table; and also, passes the translation ID to the checksum difference storing section 004 (corresponding to “field value storing means” of the present invention). This processing is performed in the case where the translation ID corresponding to the pre-translated field value currently being processed has not been stored in the table. In such a case, the replacement data generating section 001 also passes the pre-translated field value and the translated value to the checksum difference calculating section 003.

On the other hand, in the case where the translation ID corresponding to the pre-translated field value currently being processed has been stored in the table, the replacement data generating section 001 reads out the corresponding translation ID and passes the translation ID to the checksum difference storing section 004.

The field translating section 002 receives the input packet and rewrites the field value included in the header that is to be the translation subject, thereby rewriting the value to the translated value received from the replacement data generating section 001. After that, the field translating section 002 passes the packet (translated packet) to the checksum translating section 005.

The checksum difference calculating section 003 (corresponding to “calculating means” of the present invention) uses the received pre-translated field value and translated value to calculate a checksum difference value, and passes this to the checksum difference storing section 004 and the multiplexer MUX.

The checksum difference storing section 004 (corresponding to “difference value storage means” of the present invention) connects the checksum difference value received from the checksum difference calculating section 003 with the translation ID received from the replacement data generating section 001, thereby storing them. That is, the checksum difference storing section 004 matches the translation ID, which corresponds to the pre-translated field value and the translated value used when the checksum difference value is calculated, to the calculated checksum difference value, and stores them. This processing is performed in the case where the checksum difference storing section 004 has not stored the translation ID received from the replacement data generating section 001. In contrast, in the case where the checksum difference storing section 004 has already stored the translation ID received from the replacement data generating section 001, it reads out the checksum difference value corresponding to the received translation ID and passes the checksum difference value to the multiplexer MUX.

The checksum translating section 005 (corresponding to “rewriting means” of the present invention) uses the checksum value stored in the translated packet received from the field translating section 002, and the checksum difference value received from the checksum difference calculating section 003 or from the checksum difference storing section 004, to calculate, rewrite and output a checksum value of the translated packet.

The multiplexer MUX receives a control signal from the replacement data generating section 001, and in accordance with the control signal, controls a selection of a signal to pass to the checksum translating section 005, from among input signals from the checksum difference calculating section 003 and the checksum difference storing section 004.

In the case where the table in the replacement data generating section 001 has already stored the translation ID corresponding to the pre-translated field value currently being processed, the multiplexer MUX passes the signal inputted from the checksum difference storing section 004 to the checksum translating section 005. In contrast, in the case where the table in the replacement data generating section 001 has not stored the translation ID corresponding to the pre-translated field value currently being processed, the multiplexer MUX passes the signal inputted from the checksum difference calculating section 003 to the checksum translating section 005.

However, detailed constructions of the replacement data generating section 001 and the field translating section 002 are beyond the scope of the present invention.

Next, explanation is made of an operation of the header translation device 000 shown in FIG. 1. When the input packet is inputted, the replacement data generating section 001 generates the translated value, or reads the translated value out from the table, and passes it to the field translating section 002. The field translating section 002 rewrites the pre-translated field value in the input packet to the translated value received from the replacement data generating section 001. At this point, subsequent operations are different in (1) the case where the translation ID, which corresponds to the pre-translated field value to be an object of the translation processing by the field translating section 002 and the translated value, has not been stored in the table in the replacement data generating section 001, and (2) the case where the translation ID has already been stored in the table.

First, explanation is made of the case where the translation ID has not been stored in the table. The replacement data generating section 001 extracts the pre-translated field value from the header of the input packet, and passes the pre-translated field value and the translated value to the checksum difference calculating section 003. At the same time, the replacement data generating section 001 stores the pre-translated field value, the translated value and the newly generated translation ID in the table, and passes the newly generated translation ID to the checksum difference storing section 004.

The checksum difference calculating section 003 uses the pre-translated field value and the translated value received from the replacement data generating section 001 to calculate the checksum difference value, and passes the checksum difference value to the checksum difference storing section 004 and the multiplexer MUX.

The checksum difference storing section 004 matches the translation ID received from the replacement data generating section 001 and the checksum difference value received from the checksum difference calculating section 003, and stores them.

The multiplexer MUX passes the signal inputted from the checksum difference calculating section 003 to the checksum translating section 005.

The checksum translating section 005 uses the checksum difference value received from the checksum difference calculating section 003 via the multiplexer MUX and the checksum value of the packet received from the field translating section 002 to calculate the checksum value of the translated packet, and rewrites the checksum value of the packet, thereby correcting the checksum value of the packet after the field is translated.

Next, explanation is made of the case where the translation ID has already been stored in the table. The replacement data generating section 001 uses the pre-translated field value currently being processed and the translated value to read out the translation ID from the table, and passes the translation ID that has been read out to the checksum difference storing section 004.

The checksum difference storing section 004 reads out the checksum difference value corresponding to the translation ID received from the replacement data generating section 001, and passes the checksum difference value that has been read out to the multiplexer MUX. The multiplexer MUX passes the signal inputted from the checksum difference storing section 004 to the checksum translating section 005, and the checksum translating section 005 uses the checksum difference value received from the checksum difference storing section 004 via the multiplexer MUX, and the checksum value of the packet received from the field translating section 002, to calculate the checksum value of the translated packet, and rewrites the checksum value of the packet, thereby correcting the checksum value of the packet after the field is translated.

In FIG. 1, the checksum difference storing section 004 and the checksum translating section 005 are indispensable constructions for reducing the time required for recalculation of the checksum performed at the time of the header translation, and the replacement data generating section 001, the field translating section 002, the checksum difference calculating section 003 and the multiplexer MUX are additional constructions.

Hereinafter, embodiments of the header translation device are explained using diagrams. Note that the constructions of the embodiments are examples, and the present invention is not limited to the constructions of the following embodiments.

<First Embodiment>

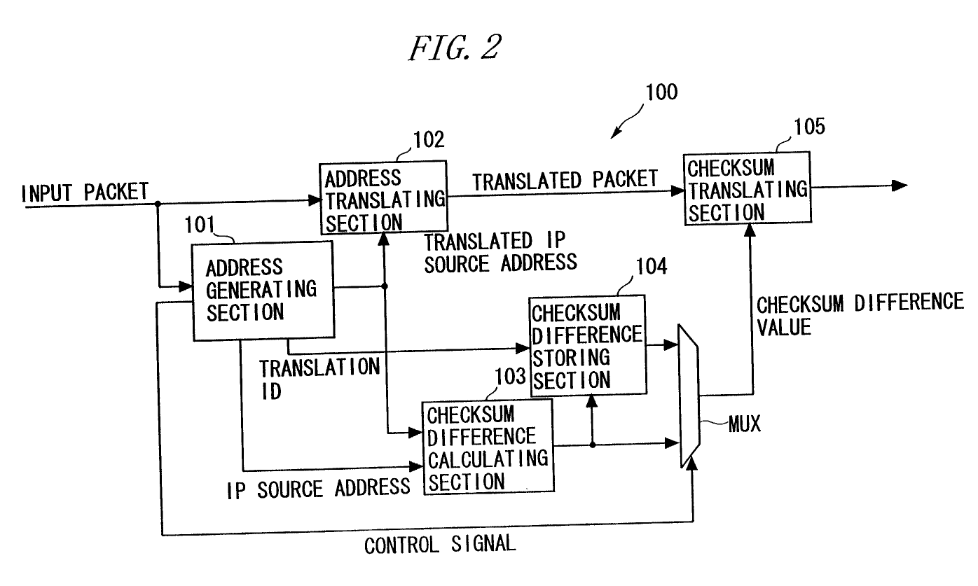

FIG. 2 is a functional block diagram of an IP address translation (Network Address Translation: NAT) system 100, serving as the header translation device according to a first embodiment of the present invention. The NAT includes static NAT for translating an address from a specific value to a specific value at a ratio of one to one, and dynamic NAT for allocating one address from among usable addresses at communication start and releasing it at communication end. In the first embodiment, a NAT system 100 applying the dynamic NAT is disclosed. However, it is also possible to use the static NAT for the NAT system 100 to which the present invention is applied. In the case where the static NAT is used, a checksum difference calculating section 103 and the multiplexer MUX are not necessarily required. Hereinafter, explanation is made of each construction of the NAT system 100 shown in FIG. 2.

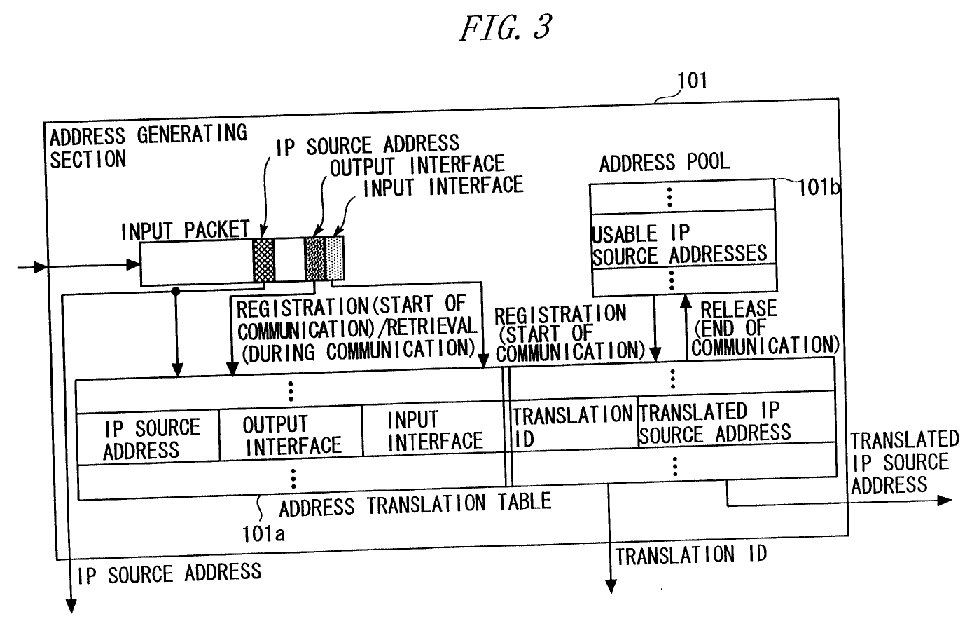

FIG. 3 is a diagram showing in detail an address generating section 101. The address generating section 101 is equipped with an address translation table 101a and an address pool 101b. The address translation table 101a matches a group from the fields included in the header of the input packet including an input interface and a IP source address and an output interface of the terminal currently executing the communication, to a group including a IP source address of a translated and the translation ID, and stores these.

The address pool 101b has IP addresses set which is usable as candidates for the IP source address on the translated, and stores the set IP addresses. Here, each of the constructions of the first embodiment is explained separately with respect to the case where it is judged that the IP source address in the header of the input packet has not been stored in the address translation table 101a (the time when this judgement is made is referred as the start of communication), and the case where the IP source address has been recorded in the address translation table 101a (this state is referred to as during communication).

First, explanation is made of the start of communication. The address generating section 101 selects one IP source address for the translated from the address pool 101b, and matches the values of the input interface, the IP source address and the output interface which are in the input packet, to the selected translated IP source address and the newly generated translation ID, and stores them in the address translation table 101a. At this time, the address generating section 101 passes the IP source address stored in the input packet header to the checksum difference calculating section 103 as the pre-translated field value, passes the translated IP source address to the address translating section 102 and the checksum difference calculating section 103 as the translated value, and passes the translation ID to a checksum difference storing section 104.

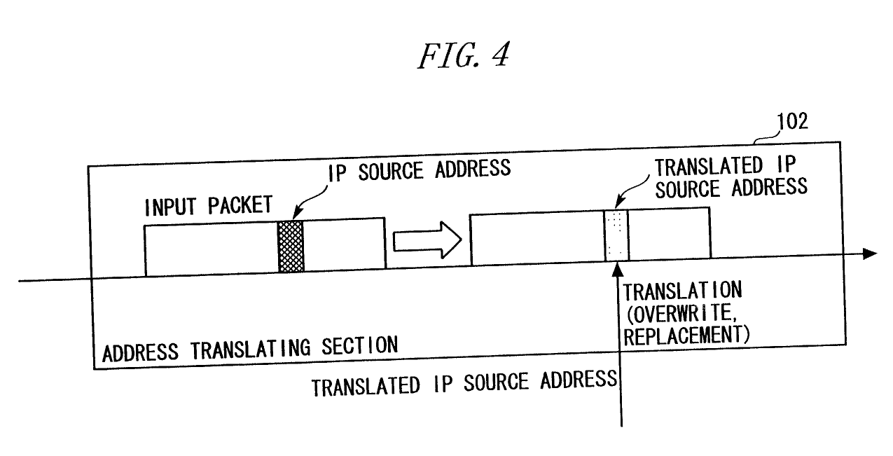

FIG. 4 is a diagram showing in detail the address translating section 102. The address translating section 102 overwrites the input packet's IP source address with the translated IP source address received from the address generating section 101, and generates the translated packet. Then, the address translating section 102 passes the generated translated packet to the checksum translating section 105.

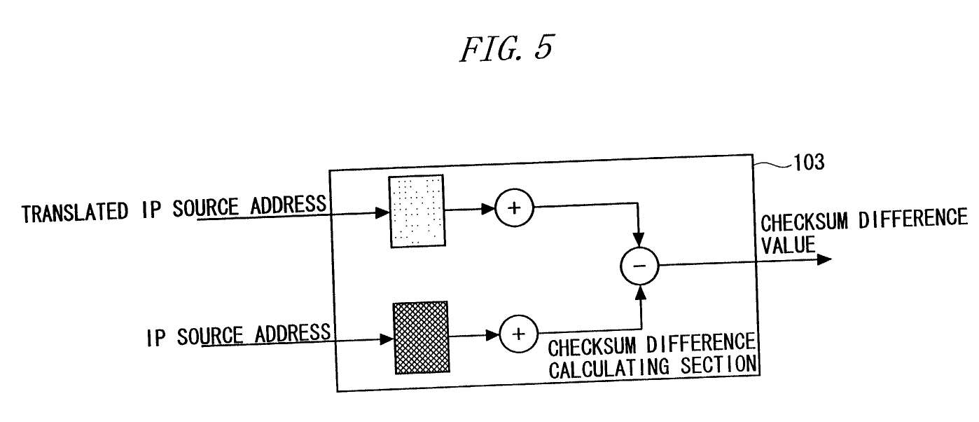

FIG. 5 is a diagram showing in detail the checksum difference calculating section 103. The checksum difference calculating section 103 subtracts the 16-bit 1's complement sum of the IP source address of the input packet, from the 16-bit 1's complement sum of the IP source address on the translated passed from the address generating section 101, and calculates the checksum difference value Then, the checksum difference calculating section 103 passes the calculated checksum difference value to the checksum difference storing section 104 and the multiplexer MUX.

The multiplexer MUX passes the inputted signal from the checksum difference calculating section 103 to the checksum translating section 105.

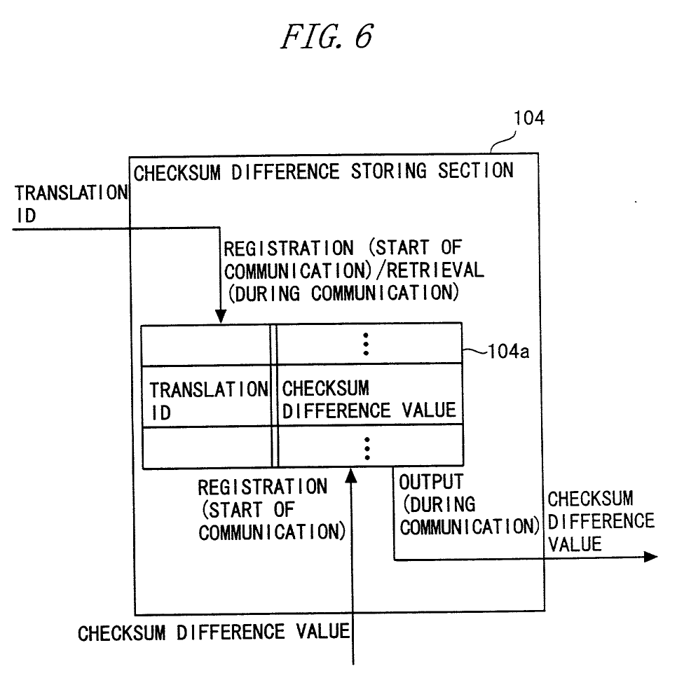

FIG. 6 is a diagram showing in detail the checksum difference storing section 104. The checksum difference storing section 104 has a table 104a for matching the translation ID passed from the address generating section 101, to the checksum difference value passed from the checksum difference calculating section 103, and storing these.

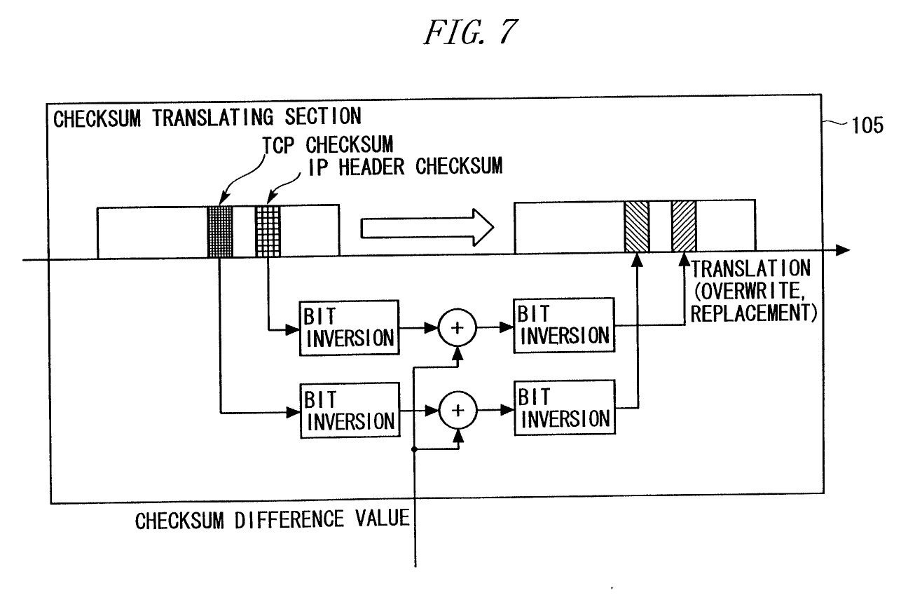

FIG. 7 is a diagram showing in detail the checksum translating section 105. The checksum translating section 105 inverts each bit of the IP header checksum value and TCP checksum value in the input packet, inverts them again after adding the checksum difference value passed from the checksum difference calculating section 103 via the multiplexer MUX, and overwrites the obtained value in the corresponding field.

The IP header checksum value and the TCP checksum value are both calculated using the values of the plurality of fields that include the IP source address field. In the first embodiment, the field that has its value rewritten is only the IP source address field; therefore, the checksum difference values of the before and after-translation IP header checksum value and the TCP checksum value, have the same values. Accordingly, the IP header checksum value and the TCP checksum value may be calculated using one checksum difference value.

Next, explanation is made of the state of during communication. The address generating section 101 uses the values of the input interface, the IP source address and the output interface in the input packet, reads out the translated IP source address and the translation ID from the address translation table 101a, passes the translated sender address to the address translating section 102, and passes the translation ID to the checksum difference storing section 104. The operations of the address translating section 102 are the same as those at the start of communication.

The checksum difference storing section 104 reads out the checksum difference value corresponding to the translation ID passed from the address generating section 101, and passes it to the multiplexer MUX. The operations of the checksum translating section 105 are the same as those at the start of communication, except for that the checksum difference value is received from the checksum difference storing section 104 via the multiplexer MUX.

At the end of communication, the address generating section 101 returns the translated IP source address stored in the address translation table 101a to the address pool 101b.

Here, as communication start detection means, a method was explained in which it is detected that the IP source address of the input packet is not on the address translation table 101a. However, it is also possible to detect the start of the TCP connection. Further, as communication end detection means, it is also possible to detect the end of the TCP connection, and also to use a timeout. Further, translation of the IP source address was described, but translation of a IP destination address may be performed.

Further, in the address translation table 101a, the address generating section 101 may match the input interface, the sender address and the output interface of the input packet to the translated sender address and the checksum difference value, and store these.

Further, in the case where the static NAT is employed, it is also possible to set the content of the address translation table 101a before the start of the communication and store the content, and calculate and store the checksum difference value in advance.

As shown in the example shown in the first embodiment, in the case where the scope covered by a checksum of a second header (TCP/UDP header) extends to the first header (IP header) when only the value of the first header has been translated and there is no change in the value of the second header (TCP/UDP header), the checksum of the second header may be recalculated using the difference value of the first header (the IP header). Therefore, in the present invention, the one checksum difference value obtained by the translation of the value of the predetermined field (the sender address) in the first header may be used to recalculate respective checksums in the first header (the IP header) and the second header (the TCP/UDP header).

In accordance with the first embodiment, in the case where the checksum difference value, which corresponds to the IP source address and the translated IP source address in the packet being processed, is stored in the checksum difference storing section 004, the difference value stored in the checksum difference storing section 004 is used to calculate the translated packet's checksum. Accordingly, it is not necessary to calculate the difference value between the IP source address and the translated IP source address every time. As such, it becomes possible to shorten the amount of processing time by subtracting from the amount of processing time required for the difference value calculation, the amount of processing time required to retrieve the corresponding checksum value in the checksum difference storing section 004. Generally, since the amount of processing time required for the difference value calculation is greater than the amount of processing time required to retrieve the corresponding checksum difference value in the checksum difference storing section 004, it is possible to shorten the amount of time required for the recalculation of the checksum.

Further, in accordance with the first embodiment, since the field value to be rewritten is only the IP source address, the IP header checksum value and the TCP header checksum value are calculated using one checksum difference value. Accordingly, it is not necessary to store a plurality of difference values, and a storage area may be used effectively.

<Second Embodiment>

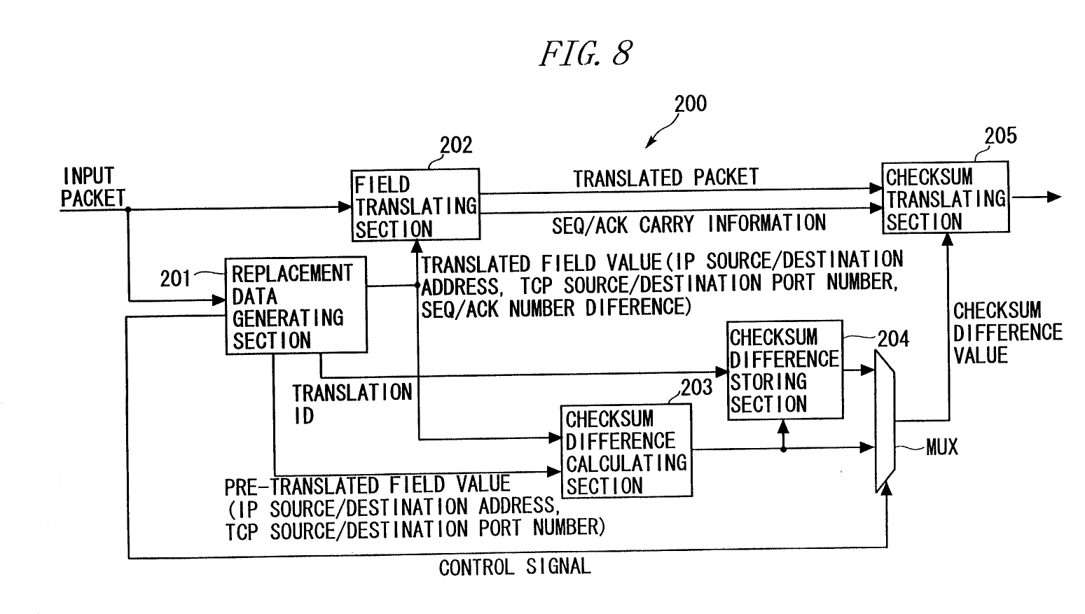

FIG. 8 is a functional block diagram of a URL load distributing system 200 according to a second embodiment of the present invention. Hereinafter, explanation is made of respective constructions of the URL load distributing system 200 shown in FIG. 8.

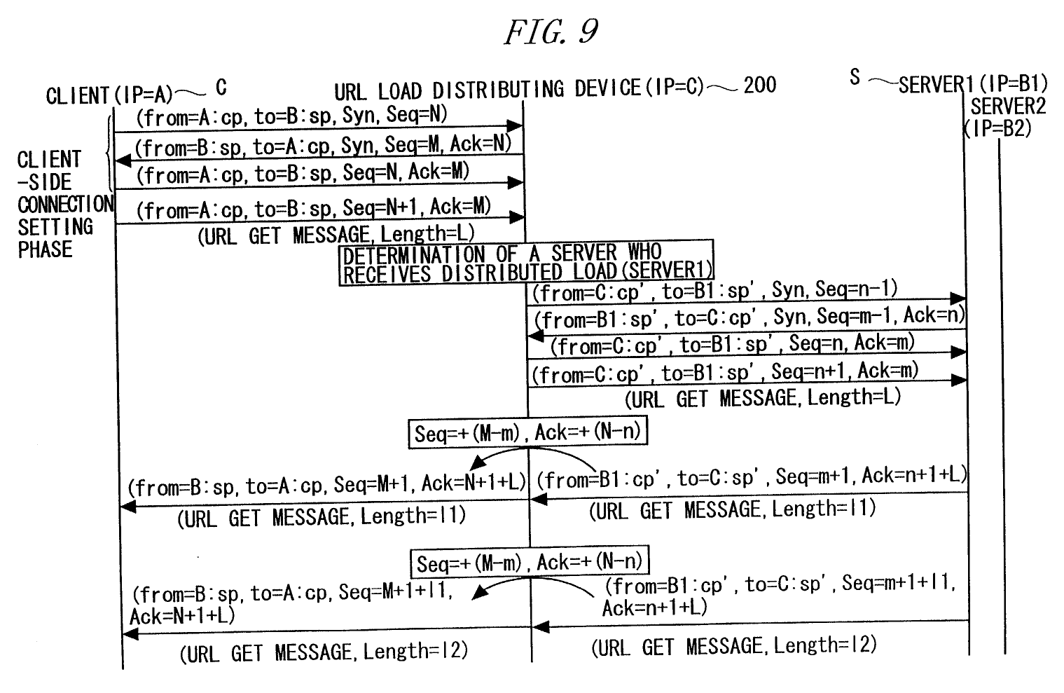

FIG. 9 is a diagram showing data handled among a client C, the URL load distributing system 200 and a server S at a URL load distributing time. The URL load distributing system 200 establishes the TCP connection with the client C, and after that uses URL information contained in a Get message from the client C to determine the server S for the communication. After that, the URL load distributing system 200 establishes a connection with the server S, and data packet exchanges are conducted between connections of both. At this time, it is necessary to perform translation of the IP address, a TCP port number and a Seq/Ack number (Sequence/Acknowledge number) in a data packet that is an object of the exchange.

For example, the URL load distributing system 200 translates the IP address and the TCP port number in the data packet received from the server S so as to correspond to the client C, and further adds “M-m” to the Seq value and adds “N-n” to the Ack value.

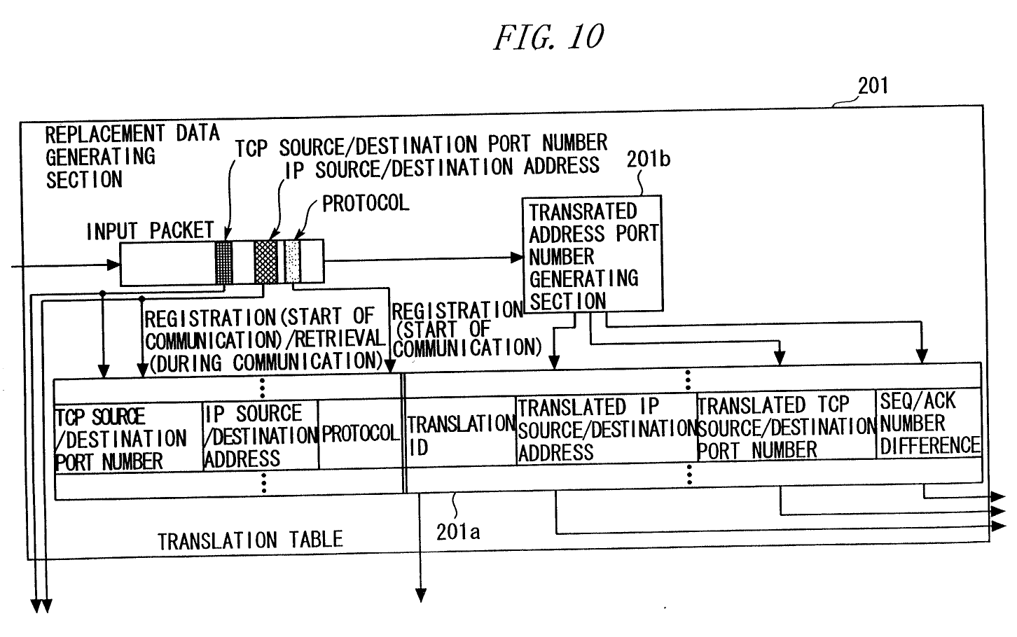

FIG. 10 is a diagram showing in detail a replacement data generating section 201. The replacement data generating section 201 is equipped with a translation table 201a and an after-translation address/port number generating section 201b.

The translation table 201a matches the IP source address, the IP destination address, a TCP source port number and a TCP destination port number from the input packet (these values are referred to as “pre-translated field values”), to the IP source address, the IP destination address, the TCP source port number, the TCP destination port number on the translated, a Seq number difference value and an Ack number difference value (these values are referred to as “translated values”), and stores these. Then, the replacement data generating section 201 sets the translation table 201a at the time when the connection is established to the server S.

The after-translation address/port number generating section 201b has IP addresses and TCP port numbers set that are usable as candidates for the IP source address, the IP destination address, the TCP source port number and the TCP destination port number on the translated, and stores the set values. Here, the respective constructions of the second embodiment are explained separately with respect to the case where it is judged that the IP source address in the input packet header has not been stored in the address translation table 201a (the time when this judgement is made is referred as the connection establishment time), and the case where the IP source address has been stored in the address translation table 201a (this state is referred to as during communication).

First, explanation is made of the connection establishment time. The replacement data generating section 201 selects the IP source address, the IP destination address, the TCP source port number and TCP destination port number on the translated from the after-translation address/port number generating section 201b, and matches the selected values, the difference values of the Seq and Ack numbers and a newly generated translation ID, to the pre-translated field value, and stores these in the translation table 201a. At this time, the pre-translated field value is passed to the checksum difference calculating section 203, the translated value is passed to the field translation section 202 and the checksum difference calculating section 203, and the translation ID is passed to a checksum difference storage section 204.

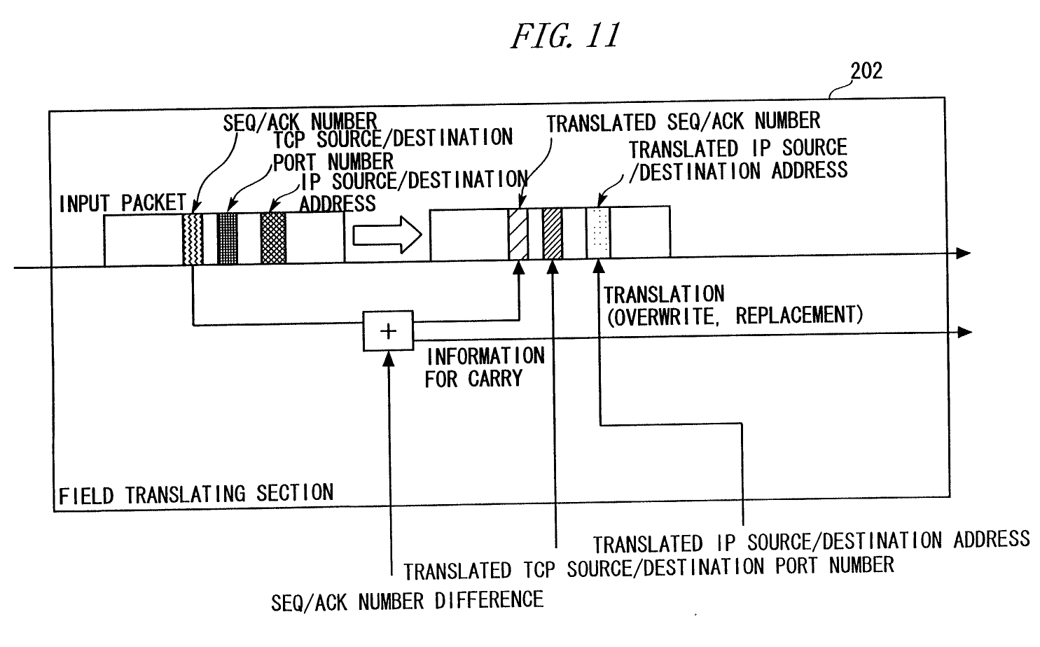

FIG. 11 is a diagram showing in detail the field translation section 202. The field translation section 202 rewrites the packet's IP source address, IP destination address, TCP source port number and TCP destination port number, to the values passed from the replacement data generating section 201. Simultaneously, it adds the respective difference values received from the replacement data generating section 201 to the Seq number and the Ack number of the input packet. At this time, information for carry generated by adding the Seq number and the Ack number is informed to a checksum difference translation section 205.

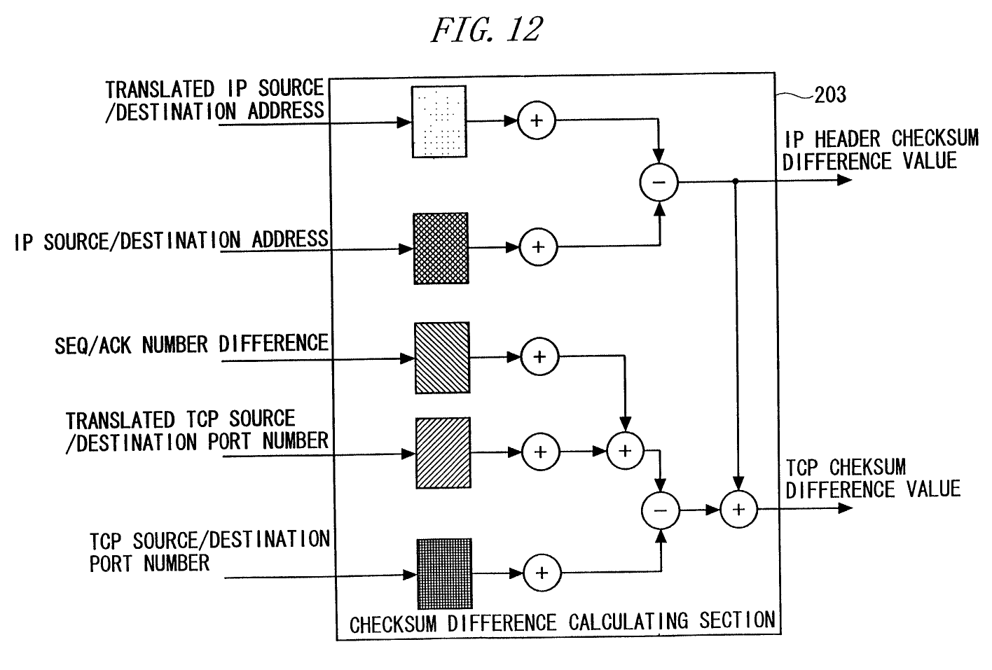

FIG. 12 is a diagram showing in detail the checksum difference calculating section 203. The checksum difference calculating section 203 uses the pre-translated field value and the translated value and calculates the TCP checksum difference value and the IP header checksum difference value, and passes these to the checksum difference storage section 204 and the checksum translating section 205. First, the IP header checksum difference value is calculated by performing 1's complement subtraction of subtracting the 16-bit 1's complement sum of the IP source address and the IP destination address from the 16-bit 1's complement sum of the translated IP source address and IP destination address. Next, the 16-bit 1's complement sum of the TCP source port number and the TCP destination port number in the input packet is subtracted from the 16-bit 1's complement sum of the Seq number, the Ack number and the TCP source port number and the TCP destination port number on the translated. Then, the 16-bit 1's complement sum of this result and the IP header checksum difference value computed above is calculated, to obtain the TCP checksum difference value.

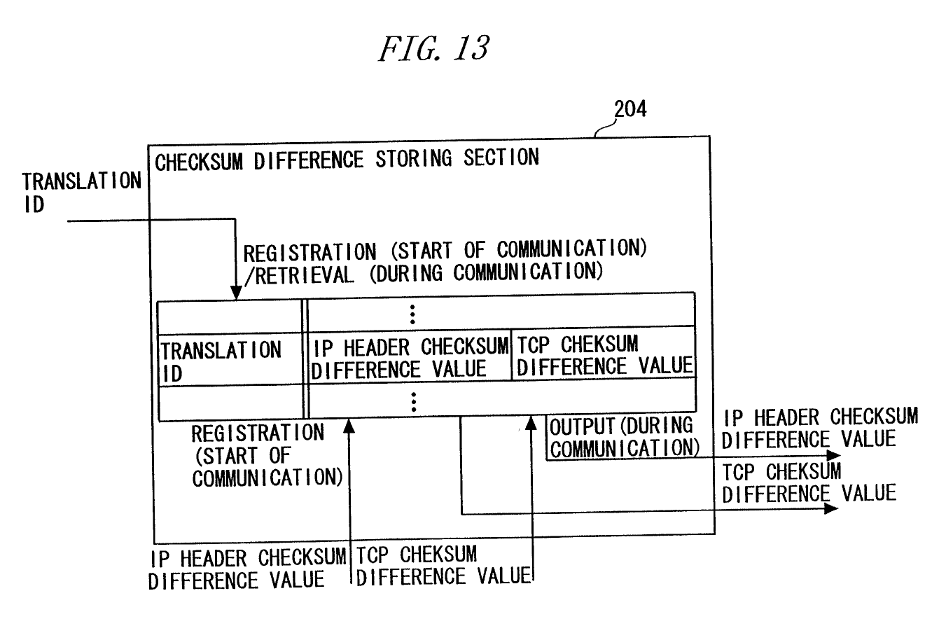

FIG. 13 is a diagram showing in detail the checksum difference storage section 204. The checksum difference storage section 204 matches the translation ID passed from the replacement data generating section 201 to the IP header checksum difference value passed from the checksum difference calculating section 203 and the TCP checksum difference value, and stores these.

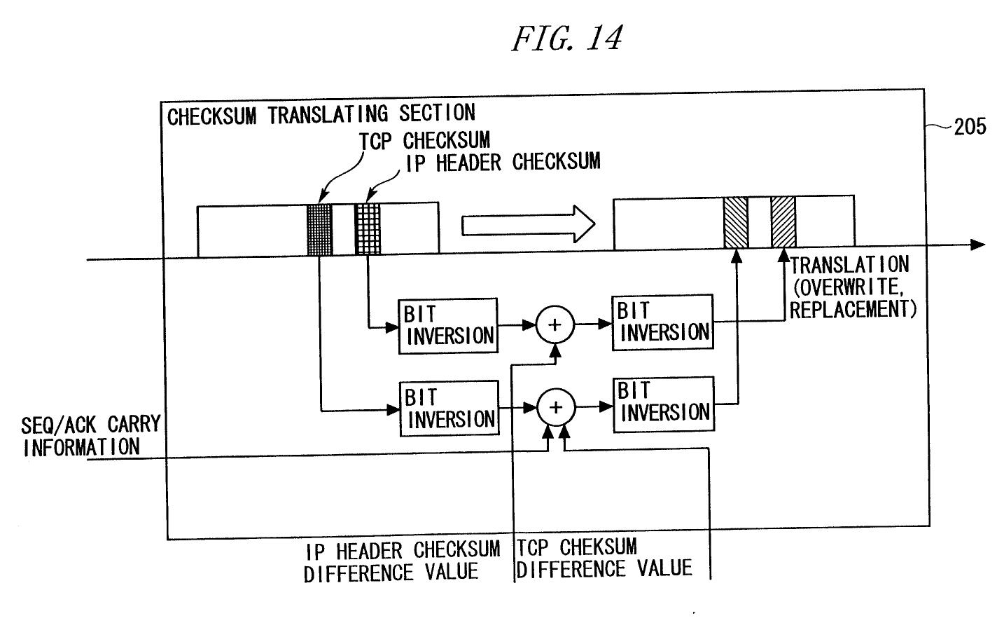

FIG. 14 is a diagram showing in detail the checksum translating section 205. The checksum difference translating section 205 calculates the IP header checksum value and the TCP checksum value. The bits of the IP header checksum value of the input packet are inverted, and then inverted again after adding the IP header checksum difference value passed from the checksum difference calculating section 203, and the obtained value is written over as the IP header checksum value. Further, each bit of the TCP checksum value of the input packet is inverted, and after the TCP checksum difference value passed from the checksum difference calculating section 203 via the multiplexer MUX is added, the information for carry passed from the field translating section 202 is referenced and bit inversion is again performed, thereby executing correction of the TCP checksum value.

Next, explanation is made of the state of during communication. The replacement data generating section 201 reads out the translated value corresponding to the input packet's pre-translated field value and the translation ID from the translation table 201a, passes the translated value to the field translation section 202, and passes the translation ID to the checksum difference storage section 204. The operations of the field translation section 202 are the same as those at the connection establishment time.

The checksum difference storage section 204 reads out the IP header checksum difference value and the TCP checksum difference value that correspond to the translation ID passed from the replacement data generating section 201, and passes the values read out to the multiplexer MUX.

The operations of the checksum translating section 205 are the same as those at the connection establishment time, except for receiving the checksum difference value from the checksum difference storage section 204 via the multiplexer MUX.

At the communication end, the replacement data generating section 201 returns the IP source address, the IP destination address, the TCP source port number and the TCP destination port number on the translated stored in the translation table 201a to the after-translation address/port number generating section 201b.

Here, the replacement data generating section 201 may match the pre-translated field value and the translated value and each checksum difference value in the translation table 201a and store them there.

Further, in the case where the static NAT is used, the content of the translation table 201a may be set and stored before the communication start, and each of the checksum difference values may be calculated and stored in advance.

In accordance with the second embodiment, the TCP checksum difference value and the IP header checksum value are each calculated and stored respectively. Accordingly, this embodiment may also be used in the case where the subject field of the IP header checksum and TCP header checksum calculations are to be rewritten to the subject field of the TCP header checksum calculation only.

Further, in accordance with the second embodiment, the plurality of fields to be an object of the TCP header checksum calculation are calculated at once and stored as one TCP header checksum difference value. Accordingly, it is not necessary to store a plurality of TCP checksum difference values that correspond to each field.

<Third Embodiment>

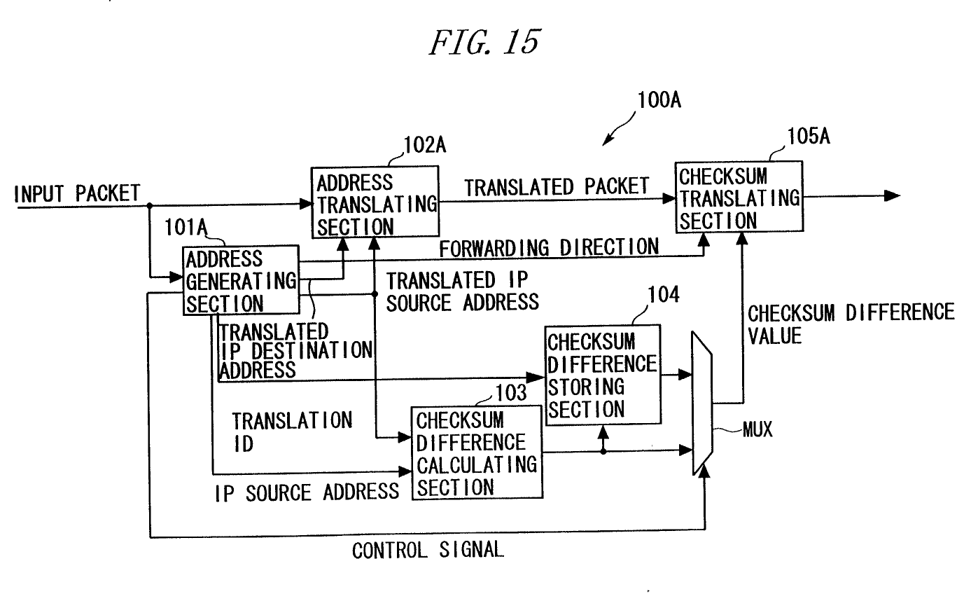

FIG. 15 is a functional block diagram of a NAT system 100A according to a third embodiment of the present invention. Hereinafter, explanation is made of each construction of the NAT system 100A shown in FIG. 15. However, only constructions which differ from the first embodiment are explained.

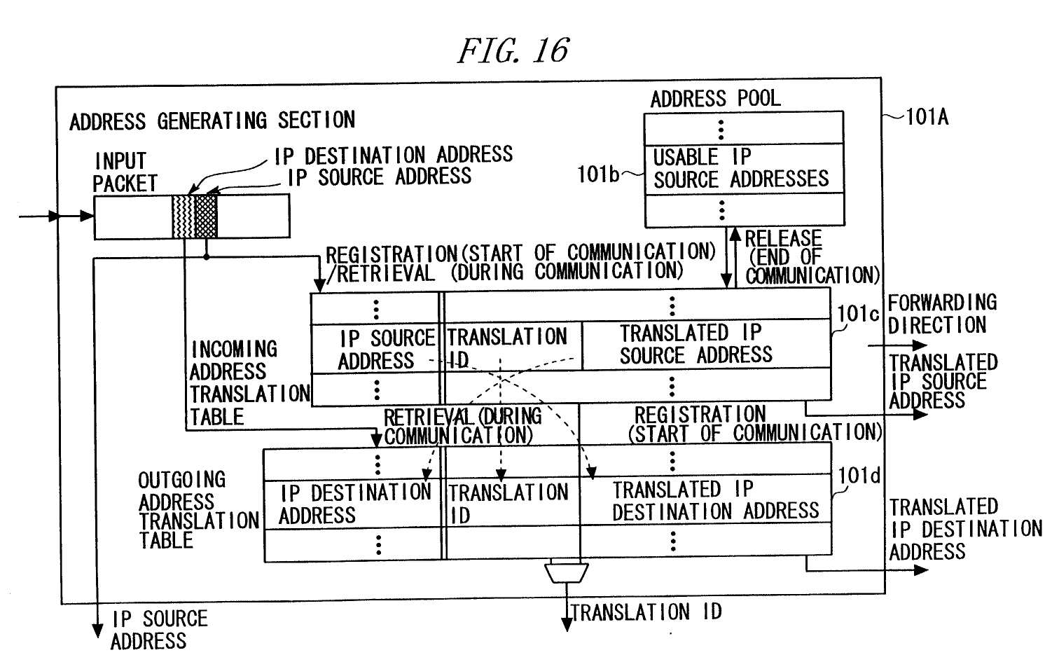

FIG. 16 is a diagram showing in detail an address generating section 101A in the third embodiment. The address generating section 101A is equipped with an address pool 101b, an incoming address translation table 101c and an outgoing address translation table 101d.

The incoming address translation table 101c has a construction similar to the address translation table 101a in the first embodiment. At the start of communication, the outgoing address translation table 101d treats the input packet's IP source address and its translated IP source address, which are stored in the incoming address translation table 101c, as the translated IP destination address and as the IP destination address respectively, and matches the IP destination address, the translated IP destination address and the translation IDs corresponding to these IP addresses in the incoming address translation table 101c, and stores these.

In the state of during communication, the address generating section 101A uses the IP destination address and the IP source address in the input packet to retrieve the outgoing address translation table 101d and the incoming address translation table 101c respectively, and reads out the corresponding translation ID and translated IP source address or translated IP destination address. At this time, one search result is produced, and either the IP source address on the translated or the IP destination address on the translated will be read out. In the case where this read-out IP address is the translated IP source address read out from the incoming address translation table 101c, the address generating section 101A passes this read-out translated IP source address to the address translating section 102A, and passes information indicating that the incoming direction is the forwarding direction to the checksum translating section 105A. In contrast, in the case where the read-out IP address was the translated IP destination address read out from the outgoing address translation table 101d, the address generating section 101A passes this read-out IP destination address to the address translating section 102A, and passes information indicating that the outgoing direction is the forwarding direction to the checksum translating section 105A.

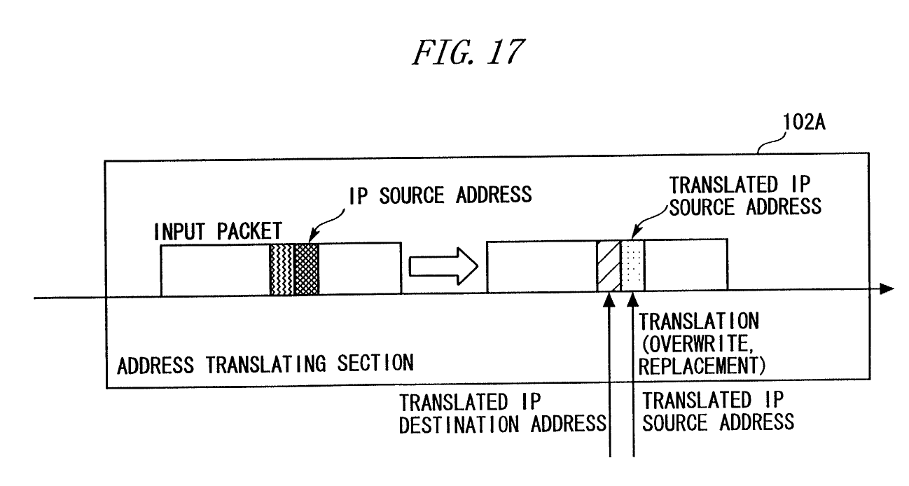

FIG. 17 is a diagram showing in detail the address translating section 102A in the third embodiment. In the case where the information passed to the address translating section 102A from the address generating section 101A was the translated IP destination address, the address translating section 102A uses this information to write over the input packet's IP destination address using the information, and in the case where the information was the translated IP source address, it uses this information to write over the input packet's IP source address.

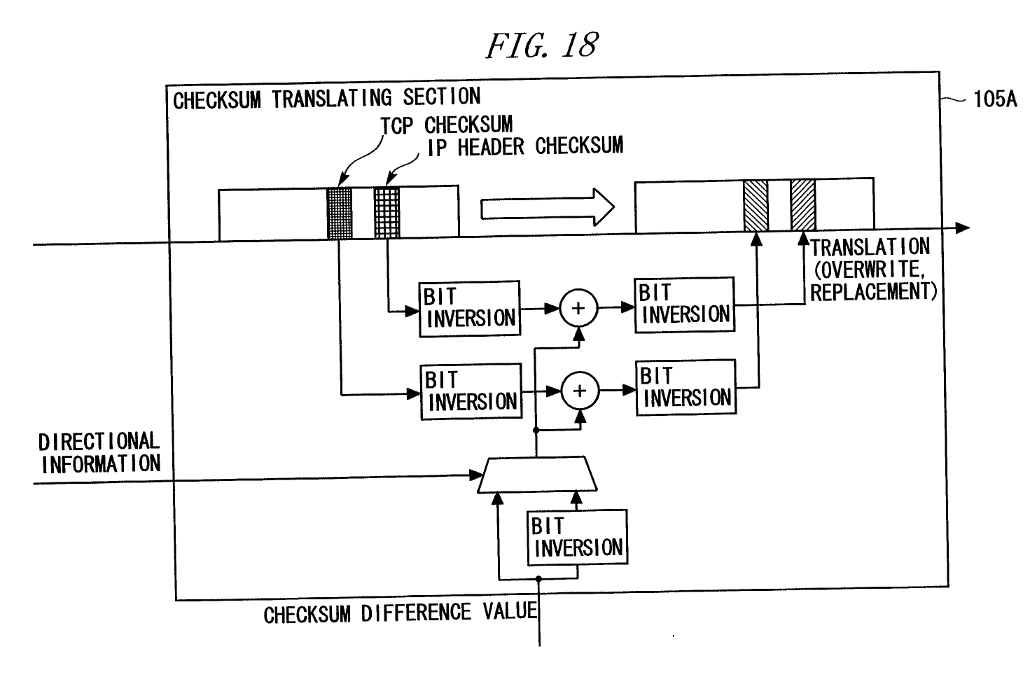

FIG. 18 is a diagram showing in detail the checksum translating section 105A according to the third embodiment. The checksum translating section 105A performs processing on the checksum difference value used to calculate the IP header checksum and the TCP checksum, according to the directional information passed from the address generating section 101A.

Specifically, in the case where the directional information indicated the incoming direction, the checksum difference value is used as is, and in the case where the directional information indicated the outgoing direction, the checksum difference value is inverted and then used. The values of the IP header checksum and the TCP checksum are derived in the same way as that in the first embodiment.

In the third embodiment, in the case where the checksum value is calculated using a difference value in single-direction communication, the difference value that was used in communication to calculate the checksum value in one direction is also used in the other direction. Accordingly, the embodiment is effective in the case where two-way communication is conducted between a client and a server.

The construction utilizing the directional information in the third embodiment may also be applied to the second embodiment.

In accordance with the third embodiment, in two-way communication, the checksum difference storage section 004 stores only one checksum difference value. In the case where the communication is in the incoming direction, namely in the case where the IP source address and the translated IP source address are the same when the checksum difference value is calculated, the checksum difference value is used as is, and the translated packet's checksum is calculated. On the other hand, in the case where the communication is in the outgoing direction, the value obtained by inverting the bits of the checksum difference value stored in the checksum difference storage section 004, is used to calculate the translated packet's checksum. Accordingly, it is not necessary to store two difference values in the incoming direction and in the outgoing direction.

What is claimed is:

1. A checksum rewriting device comprising:
a translating means for, in a case where a packet having at least one header consists of a plurality of fields including a checksum field is inputted, translating a value of a predetermined field other than the checksum field;
a difference value storing means for storing a checksum difference value calculated using a pre-translated value and a translated value of the predetermined field which is translated by the translating means; and
a rewriting means for rewriting the value of the checksum field in the header in the packet in which the predetermined field value has been translated by the translating means, to a new value, using the difference value stored in the difference value storing means.

2. A checksum rewriting device according to claim 1 further comprising:
a field value storing means for storing the pre-translated value and the translated value of the predetermined field, and giving to the translating means the translated value corresponding to the packet which is inputted to the translating means; and
a calculating means for calculating a checksum difference value, using the pre-translated value and the translated value of the predetermined field that are stored in the field value storing means;
wherein the difference value storing means stores the difference value calculated by the calculating means; and
the rewriting means receives the difference value from the difference value storing means in a case where the difference value is stored in the difference value storing means, and receives the difference value from the calculating means in a case where the difference value is not stored in the difference value storing means.

3. A checksum rewriting device according to claim 1, wherein the header is an IP header, and the predetermined field includes a IP source address field and/or a IP destination address field of the IP header.

4. A checksum rewriting device according to claim 1, wherein the header is a TCP or UDP header, and the predetermined field includes a sender port number field and/or a destination port number field of the TCP or UDP header.

5. A checksum rewriting device according to claim 1, wherein the header is a TCP header, and the predetermined field includes a Sequence number field and an Acknowledge number field of the TCP header.

6. A checksum rewriting device comprising:
a translation means for, in a case where a packet is inputted having at least a first header and a second header each consists of a plurality of fields including a checksum field, translating a value of a predetermined field of the first header other than the checksum field;
a difference value storing means for storing a checksum difference value calculated using a pre-translated value and a translated value of the predetermined field; and
a rewriting means for rewriting at least one value of the checksum fields provided to the first header and second header respectively in the packet in which the predetermined field value was translated by the translating means, to a new value, using the difference value stored in the difference value storing means.

7. A checksum rewriting device comprising:
a translation means for, in a case where a packet is inputted having at least a first header and a second header each consists of a plurality of fields including a checksum field, translating a value of a predetermined field of the first header other than the checksum field;
a difference value storing means for storing a checksum difference value calculated using a pre-translated value and a translated value of the predetermined field; and
a rewriting means for rewriting both values of the checksum fields provided to the first header and second header respectively in the packet in which the predetermined field value has been translated by the translating means, to new values, using the difference value stored in the difference value storing means.

8. A checksum rewriting device according to claim 6, wherein the first header is an IP header, the second header is a TCP or UDP header, and the predetermined field includes a sender address field and/or a destination address field of the IP header.

9. A checksum rewriting device comprising:
a translation means for, in a case where a packet is inputted having at least a first header and a second header each consists of a plurality of fields including a checksum field, translating values of predetermined fields of the first and the second header respectively other than the checksum fields;
a difference value storing means for storing a first checksum difference value calculated using a pre-translated value and a translated value of the predetermined field of the first header, and a second checksum difference value calculated using a pre-translated value and a translated value of the predetermined field of the first and the second header; and
a rewriting means for rewriting a value of the checksum field provided to the first header in the packet in which the predetermined field values of the first and the second header have been translated by the translating means, to a new value, using a first checksum difference value stored in the difference value storing means, and rewriting a value of the checksum field provided to the second header in the packet in which the predetermined field values of the first and the second header have been translated by the translating means, to a new value, using a second checksum difference value stored in the difference value storing means.

10. A checksum rewriting device according to claim 9 further comprising:
a field value storing means for storing the pre-translated value and the translated value of the predetermined fields of the first and the second headers, and giving to the translating means the translated value corresponding to the packet which is inputted to the translating means; and
a calculating means for calculating the first and the second checksum difference value, using the pre-translated value and the translated value of the predetermined fields of the first and the second headers which are stored in the field value storing means, and;
wherein the difference value storing means stores the first and the second checksum difference values calculated by the calculating means; and
the rewriting means receives the first and the second checksum difference values from the difference value storing means in a case where the first and the second checksum difference values are stored in the difference value storing means, and receives the first and the second checksum difference values from the calculating means in a case where the first and the second checksum difference values are not stored in the difference value storing means.

11. A checksum rewriting device according to claim 9, wherein the first header is an IP header, the second header is a TCP or UDP header, the predetermined field of the first header includes a sender and a IP destination address fields of the IP header, and the predetermined field of the second header includes a sender and a destination port number fields of the TCP or UDP header.

12. A checksum rewriting device according to claim 9, wherein the first header is an IP header, the second header is a TCP header, the predetermined field of the first header includes a sender and a IP destination address fields of the IP header, and the predetermined field of the second header includes at least one of a sender and a destination port number fields and/or a Sequence and an Acknowledge fields of the TCP header.

13. A checksum rewriting device according to claim 1, wherein, in a case where two-way communication is conducted in which a packet forwarded in a direction and a packet forwarded in an opposite direction are inputted to the translating means, the difference value storing means stores the difference value of the packet forwarded in a direction, the rewriting means rewrites the value of the checksum field of the packet to be forwarded in the direction to a new value using the difference value stored in the difference value storing means, and rewrites the value of the checksum field of the packet to be forwarded in the opposite direction to a new value using a value obtained by inverting bits comprised the difference value stored in the difference value storing means.
